(19) United States
(12) Patent Application Publication
(10) Pub. No.: US 2007/0256251 A1
(43) Pub. Date: Nov. 8, 2007

(54) Washing and Cleaning Products Comprising Immobilized Active Ingredients

(75) Inventors: Bernhard Orlich, Dusseldorf (DE); Bernd Richter, Leichlingen (DE); Thomas Plantenberg, Mettmann (DE)

Correspondence Address: CONNOLLY BOVE LODGE & HUTZ LLP, PO BOX 2207, WILMINGTON, DE, 19899-2207, US

(73) Assignee: Henkel KGaA, Dusseldorf (DE)

(21) Appl. No.: 11/664,139

(22) PCT Filed: Aug. 25, 2005
(86) PCT No.: PCT/EP05/09155

§ 371 Date: Apr. 23, 2007

(30) Foreign Application Priority Data
Sep. 29, 2004 (DE) 10 2004 047 097.9

(51) Int. Cl. C11D 17/00; C11D 3/386

(52) U.S. Cl. 8/137; 510/418

(57) ABSTRACT

Capsules which comprise an immobilized active ingredient in a matrix, wherein the active ingredient is bound to a substrate, and cleaning/detergent compositions comprising such a capsule and a surfactant, methods for the preparation of such compositions and their use are described.

The invention relates to an aqueous, liquid detergent and cleaning agent, comprising surfactant(s) as well as further conventional ingredients of detergents and cleaning agents. The invention also relates to processes for manufacturing an aqueous, liquid detergent and cleaning agent, as well as its use.

The incorporation of certain active ingredients (e.g. bleaching agents, enzymes, perfumes, colorants etc.) into liquid detergent and cleaning agents can lead to problems. For example, incompatibilities can arise between the individual active ingredient components of the liquid detergent and cleaning agent. This can lead to unwanted discolorations, agglomerations, problems of odor, and decomposition of active washing ingredients.

However, the consumer demands liquid detergent and cleaning agents that optimally develop their activity at the time of use even after storage and transport. This requires that beforehand, the ingredients of the liquid detergent and cleaning agent have neither precipitated, decomposed nor volatilized.

The loss of volatile components, for example, can be prevented by elaborate and correspondingly expensive packaging. Chemically incompatible components can be kept separate from the remainder of the components of the liquid detergent and cleaning agent and then metered in for the application. The use of nontransparent packaging prevents the decomposition of the light-sensitive components, but has also the disadvantage that the consumer cannot see the appearance and amount of the liquid detergent and cleaning agent.

One concept for incorporating sensitive, chemically or physically incompatible and volatile ingredients consists in the use of capsules, in which these ingredients are encapsulated. There are two different kinds of capsules. On the one hand there are capsules with a core-shell structure, in which the ingredient is surrounded by a wall or barrier. On the other hand there are capsules, in which the ingredient is dispersed in a matrix of a matrix-forming material. Such capsules are also referred to as “speckles”.

EP 0 266 796 A1 describes a water-soluble microcapsule comprising enzymes, which can be stable in suspension in a concentrated aqueous, surfactant-containing solution, and which dissolves when diluted with water. The water-soluble microcapsule possesses a coating of polyvinyl alcohol.

GB 1 390 503 A discloses aqueous liquid detergents comprising capsules that are insoluble in the liquid detergent, but release their encapsulated contents as soon as the ion strength falls on dilution with water. The capsule preferably exhibits a water-soluble outer wall of cellulose ether, polyacrylate, polyvinyl alcohol or polyethylene oxide.

GB 1 461 775 A also describes aqueous liquid detergents comprising capsules that dissolve on dilution with water. The capsules comprise either hardened carragheenan or a modified pectin and a water-dispersible pigment.

WO 97/14780 describes encapsulated bleaching agents that comprise a coating of a gelled polymer material. The gelled polymer material is preferably an alginate.

WO 97/24178 describes particles with a polymeric matrix that comprises enzymes or other detergency active agents, wherein the matrix is formed from a copolymer. The matrix swells on contact with the wash water and thus allows the release of the active ingredients. Preferably, the particles have an additional outer shell of a polymeric material.

A cleaning agent composition is disclosed in EP 1 149 149 A1, which includes a matrix-encapsulated, active ingredient. The matrix of the capsule comprises a hydrated anionic gum, and the encapsulated active ingredient is preferably a fragrance.

The disadvantage of this type of capsule is that the active ingredient has to be sufficiently large, i.e. has a high enough molecular weight for the active ingredient not to diffuse out (so called “bleed out”) of the capsule into the surrounding detergent and cleaning agent. In particular, small molecules can enter the cleaning liquid this way and can cause unwanted discolorations, agglomerations, problems of odor and decomposition of detergency active ingredients or be destroyed themselves.

Accordingly, an object of the present invention is to provide a detergent and cleaning agent, comprising capsules with at least one active ingredient comprised therein, wherein the active ingredient in the capsule is immobilized.

This object is achieved by an aqueous liquid detergent and cleaning agent, comprising surfactant(s) as well as further conventional ingredients of detergents and cleaning agents, wherein the agent comprises at least one capsule, the capsule includes an active ingredient in a matrix and the active ingredient is immobilized by binding onto a substrate.

By binding onto a substrate, the size and also the molecular weight of the active ingredient increases and thus prevents or significantly minimizes any bleed out or diffusion of the active ingredient from the capsule into the surrounding detergent and cleaning agent composition.

Preferably, the substrate is specific to the active ingredient.

By adding a substrate that is specifically for the active ingredient, then an active ingredient can be targeted and effectively immobilized.

It is also preferred that the active ingredient is selected from the group of the enzymes and the metal cations.

Metal cations are small molecules that can diffuse out of the capsules particularly quickly and then provoke unwanted reactions in the surrounding detergent and cleaning agent composition. However, enzymes can also easily enter the detergent and cleaning agent composition from the capsules. The enzymes can be destroyed there by e.g. bleaching agents and are no longer available, or are available at a significantly reduced concentration, during the actual washing process. This has a negative impact on the washing and cleaning performance.

The enzyme particularly preferably forms an enzyme-substrate complex with the substrate.

Enzyme-substrate complexes are particularly stable and form very specifically. By forming such an enzyme-substrate complex, a specific enzyme can be selectively and effectively immobilized as the active ingredient in a capsule.

The enzyme is advantageously selected from the group of the cellulases, the proteases, the amylases and the lipases.

These enzymes in particular deliver an indispensable contribution to the washing and cleaning performance. Cellulases, for example, decompose carbohydrate-containing stains, whereas the proteases or the lipases respectively possess the ability to decompose protein-containing stains and exhibit adipolytic activity. The amylases show an activity for the decomposition of starch, glycogen and/or dextrin. The immobilization and consequent stabilization of one or more sensitive enzymes in capsules is therefore particularly advantageous.

A particularly preferred embodiment of the invention stipulates that the enzyme is a cellulase and the substrate is cellulose.

The cellulase is a particularly important enzyme in detergents and cleaning agents, as in addition to the decomposition of carbohydrate-containing stains, it also provides an important contribution to secondary washing performance, because it possesses an anti-redeposition action as well as smoothing and color freshening effects on textiles. The cellulose substrate is specific to the cellulases and consequently brings about an effective immobilization and stabilization of the cellulases employed in the detergent and cleaning agent.

In a preferred embodiment, the capsule further comprises at least one hollow micro sphere.

Hollow micro spheres have a diameter of 2 to 500 μm, particularly 5 to 20 μm, and a density of less than 1 g·cm⁻³. By incorporating one or more hollow micro spheres into each capsule, the density of the capsule can be matched to the density of the surrounding detergent and cleaning agent composition, thereby preventing an unwanted precipitation or buoyancy (creaming) of the capsules.

It is also preferred that the matrix is made of a material selected from the group that includes carragheenan, alginate and gellan gum.

These materials can be particularly well crosslinked with cations to form crosslinked insoluble gels. Spherical capsules comprising a matrix can be easily manufactured by dropping a solution of these materials into cation-containing solutions.

It can be preferred that the capsule further comprises a filler. This is preferably selected from the group of the silicas and the aluminum silicates.

Integrating fillers into the capsule strengthens the matrix and thus affords particularly robust capsules. Furthermore, the fillers, especially the silicas, can improve the solubility of the capsules during the actual washing process.

In a preferred embodiment, the detergent and cleaning agent comprises dispersed capsules that have a diameter along their largest dimension of 0.01 to 10 000 μm.

A process is also claimed for the production of an aqueous liquid detergent and cleaning agent, comprising surfactant(s) as well as further conventional ingredients of detergents and cleaning agents, and at least one capsule, wherein the capsule includes an active ingredient in a matrix, in which the active ingredient is bound to a substrate.

The invention also claims the use of an inventive detergent and cleaning agent for cleaning textile fabrics.

The inventive detergents and cleaning agents are described below in more detail using inter alia examples.

The inventive detergents and cleaning agents imperatively comprise at least one capsule that contains an active ingredient in a matrix, wherein the active ingredient is immobilized by being bound on a substrate.

The matrix of the capsule can include, for example, carragheenan, alginate or gellan gum. These materials can be crosslinked by monovalent or polyvalent cations to form insoluble gels.

Alginate is a naturally occurring salt of alginic acid and exists in all brown algae (phaeophycea) as a constituent of the cell wall. Alginates are acidic, carboxyl group-containing polysaccharides with a relative molecular weight M_{R} of ca. 200 000, consisting of D-mannuronic acid and L-guluronic acid in various proportions, which are linked with 1,4-glycosidic bonds. The sodium, potassium, ammonium and magnesium alginates are water-soluble. The viscosity of alginate solutions depends inter alia on the molecular weight and the counter ion. Calcium alginates form e.g. at certain proportions of constituents, thermo-irreversible gels. Sodium alginates yield very viscous solutions with water and can be crosslinked by interaction with di- or trivalent metal ions such as Ca²⁺. Ingredients that are also comprised in the aqueous sodium alginate solution are incorporated in this way in an alginate matrix.

Carragheenan is an extract of the red algae, which belong to the Florideae (Chondrus crispus and Gigartina stellata). Carragheenan crosslinks in the presence of K⁺ ions or Ca²⁺ ions.

Gellan gum is an unbranched anionic microbial heteroexopolysaccharide with a tetrasaccharidic base unit, consisting of the monomers glucose, glucuronic acid and rhamnose, wherein about each base unit is esterified with one L-glycerate and each second base unit with one acetate. Gellan gum crosslinks in the presence of K⁺ ions, Na⁺ ions, Ca²⁺ ions or Mg²⁺ ions. For the matrix, alginate is preferred among the cited materials.

Sensitive, chemically or physically incompatible and volatile components (=active substances) of the aqueous liquid detergent and cleaning agent are advantageously incorporated inside the capsule and are storage and transport-stable. In the context of this invention, these components are called “active ingredients”. Optical brighteners, surfactants, sequestrants, bleaching agents, bleach activators, dyes and/or fragrances, antioxidants, builders, enzymes, enzyme stabilizers, antimicrobials, graying inhibitors, anti-redeposition agents, pH adjustors, electrolytes, foam inhibitors, UV absorbers, cationic surfactants, vitamins, proteins, preservatives, wash strengtheners and/or pearlizers are examples of materials that can be found in the capsules, in so far as they bind to a substrate.

The amount of active ingredient in the aqueous alginate solution preferably ranges between 0.01 and 40 wt. %, more preferably between 0.05 and 20 wt. %, particularly preferably between 0.1 and 5 wt. % and especially between 0.5 and 1.5 wt. %.

All compounds, which enter into any form of bonding with an active ingredient without significantly changing the original properties of the active ingredient, can be considered as a possible substrate. The compounds that are used as the substrate preferably have a high molecular weight. Particularly preferably, the substrate is specific to the active ingredient. For the case of an enzyme as the active ingredient, it can be preferred that an enzyme-substrate complex is formed. Cellulose, for example, can be used as the substrate for encapsulating a cellulase. For encapsulating a protease, a protein is suitably employed as the substrate. When a lipase should be present as the active ingredient in a capsule, then it can be bound, for example, to a long chain triglyceride substrate. In the case of metal cations, such as Mn²⁺ as the active ingredient, then the substrate can include one or long chain ligands.

The amount of substrate in the aqueous alginate solution preferably ranges between 0.01 and 10 wt. %, more preferably between 0.2 and 5 wt. %, particularly preferably between 1 and 2 wt. %.

The capsules can additionally comprise hollow micro spheres. Hollow micro spheres are particles with a diameter of 2 to 500 μm, particularly 5 to 20 μm, and a density of less than 1 g·cm⁻³. The hollow micro spheres are advantageously round and smooth. The hollow micro spheres can be of inorganic material such as water-glass, aluminum silicate, borosilicate glass, soda lime glass or a ceramic or of organic polymers, such as for example homopolymers or copolymers of styrene, acrylonitrile and vinylidene chloride. Suitable hollow micro spheres are commercially available, for example, under the names Fillite® (Trelleborg Fillite), Expancel® (Akzo Nobel), Scotchlite® (3M), Dualite® (Sovereign Specialty Chemicals), Sphericel® (Potters Industries), Zeeospheres® (3M), Q-Cel® (PQ Corporation) or Extendospheres® (PQ Corporation). Other suitable hollow micro spheres are offered under the product name E-Spheres from the OMEGA MINERALS Company. E-Spheres are white, ceramic hollow micro spheres that are offered in various particle sizes, particle size distributions, bulk densities and bulk volumes. Many of the cited hollow micro spheres are chemically inert and after destruction of the capsule, are dispersed in the wash liquor and then evacuated with the liquor.

As already mentioned, the density of the capsules can be varied or adjusted by incorporating the hollow micro spheres. The quantity of hollow micro spheres in a capsule depends on the desired density of the capsule. However, it is preferred that the amount of hollow micro spheres in the aqueous alginate solution preferably ranges between 0 and 10 wt. %, more preferably between 1 and 5 wt. % and particularly preferably between 2 and 4 wt. %.

In addition, the capsules can also comprise fillers, preferably, such as silicas or aluminum silicates, particularly zeolites. These fillers are incorporated by adding the relevant materials to the alginate solution. Silicas that are suitable fillers are commercially available under the names Aerosil® or Sipernat® (both from Degussa). Other suitable fillers are aluminum silicates and especially zeolites. Zeolite A, Zeolite P, Zeolite X or mixtures thereof can be employed. Suitable examples of zeolites include the commercial products Wessalith® (Degussa), Zeolite MAP® (Crosfield) or VEGOBOND AX® (SASOL).

The amount of filler in the aqueous alginate solution preferably ranges between 0 and 20 wt. %, more preferably between 1 and 10 wt. %, particularly preferably between 2 and 10 wt. %.

The fillers lend the capsules a robust structure and in consequence increase the stability of the capsules. Furthermore, the fillers, especially the silicas, can improve the solubility of the capsules during the actual washing process.

In the context of the manufacturing process, the capsules can have any shape, however, they are preferably approximately spherical. Their diameter along the greatest spatial dimension can be between 0.01 μm (not visually recognizable as capsules) and 10 000 μm depending on the encapsulated components and the application. Visible microcapsules with a diameter in the range 100 μm to 7000 μm, particularly 400 μm to 5000 μm, are preferred.

On aesthetic grounds, it may be desired that the capsules be colored. For this, the capsule can comprise one or more colorants, such as a pigment or a dye. It can also be preferred that the capsule comprises a preservative.

To manufacture alginate-based capsules, an aqueous alginate solution that also comprises the encapsulatable active substances or the encapsulatable active substances and the substrate as well as optional further encapsulatable components, such as filler(s), hollow micro spheres, preservatives and colorants, is preferably dripped and then hardened in a precipitation bath containing Ca²⁺ ions. It is quite particularly preferred that the active ingredient(s) and each of the substrates are first brought into contact with each other before the aqueous alginate solution is prepared in order to ensure that the active ingredient is bound to the substrate.

The alginate capsules can be prepared, for example, by means of a dripping unit from Rieter Automatik GmbH. The dripping of the aqueous alginate solution that comprises the encapsulatable active substances and the substrate as well as optional filler(s), hollow micro spheres, preservatives and colorants, is effected by generating a vibration by means of an oscillating membrane. The break up into droplets results from the increased shear during the reverse vibration of the membrane. The dripping itself can be effected for example through a single die or a die plate with 10 to 500, preferably 50 to 100 holes. The dies preferably possess holes with a diameter in the range 0.2 to 2, preferably 0.3 to 0.8 mm. In principle, the dripping can be carried out in a precipitation bath that is laid out as a stirred tank or cauldron. However, there is the danger with this that the capsules come into contact and stick to each other. In addition, the capsules and the encapsulated active ingredients can be destroyed during stirring, as the energy input from the stirring process also leads to an unwanted increase in temperature. These disadvantages can be avoided if the precipitation bath is designed as a sort of flow channel. The dripping is effected in a uniform flow that carries away the droplets so rapidly out of the dropping zone that they do not come into contact with the following droplets and stick to them. As long as the capsules are not completely hardened, they float; as the hardening progresses they precipitate.

Other dripping units that differ in their different droplet formation technologies can also be used as alternative manufacturing processes. Examples may be cited of units from the Gouda Company, the Cavis Company or the GeniaLab Company.

The amount of alginate in the aqueous alginate solution preferably ranges between 0.01 and 10 wt. %, particularly preferably between 0.1 and 5 wt. % and especially preferably between 1 and 3 wt. %. Sodium alginate is preferably employed.

It can be advantageous to subsequently wash the alginate-based capsules with water and then wash them again in an aqueous solution with a sequestrant, such as, for example Dequest®, in order to wash out free Ca²⁺ ions that could cause unwanted interactions with the ingredients of the liquid detergent and cleaning agent, e.g. the fatty acid soaps. Finally, the alginate-based capsules are washed again with water to remove excess sequestrant.

Before their use in a detergent or cleaning agent, the capsules can be dried; however, they are preferably employed when still moist.

The release of the active substance from the capsules normally occurs during the use of the agent, by destruction of the matrix from mechanical, thermal, chemical or enzymatic action. In a preferred embodiment of the invention, the liquid detergents and cleaning agents comprise the same or different capsules in amounts of 0.01 to 10 wt. %, particularly 0.2 to 8 wt. % and most preferably 0.5 to 5 wt. %.

In addition to the capsules, the liquid detergents and cleaning agents comprise surfactant(s), wherein anionic, non-ionic, cationic and/or amphoteric surfactants can be employed. Mixtures of anionic and non-ionic surfactants are preferred from the technical viewpoint. The total surfactant content of the liquid detergent and cleaning agent is preferably below 40 wt. % and particularly preferably below 35 wt. %, based on the total liquid detergent and cleaning agent.

Preferred non-ionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain linear and methyl-branched groups in the form of the mixtures typically present in oxo alcohol groups. Particularly preferred are, however, alcohol ethoxylates with linear alcohol groups of natural origin with 12 to 18 carbon atoms, e.g. from coco-, palm-, tallow- or oleyl alcohol, and an average of 2 to 8 EO per mole alcohol. Exemplary preferred ethoxylated alcohols include C₁₂₋₁₄ alcohols with 3 EO, 4EO or 7EO, C₉₋₁₁ alcohol with 7 EO, C₁₃₋₁₅ alcohols with 3 EO, 5 EO, 7 EO or 8 EO, C₁₂₋₁₈ alcohols with 3EO, 5EO or 7EO and mixtures thereof, as well as mixtures of C₁₂₋₁₄ alcohols with 3 EO and C₁₂₋₁₈ alcohols with 7 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are tallow fatty alcohol with 14 EO, 25 EO, 30 EO or 40 EO. Also, non-ionic surfactants that comprise the EO- and PO groups together in the molecule are employable according to the invention. Here, block copolymers with EO-PO blocks or PO-EO blocks can be added, but also EO-PO-EO copolymers or PO-EO-PO copolymers. Of course, mixed alkoxylated non-ionic surfactants can also be used, in which EO- and PO-units are not in blocks but rather distributed statistically. Such products can be obtained by the simultaneous action of ethylene oxide and propylene oxide on fatty alcohols.

Furthermore, as additional non-ionic surfactants, alkyl glycosides that satisfy the general Formula RO(G)ₓ can be added, where R means a primary linear or methyl-branched, particularly 2-methyl-branched, aliphatic group containing 8 to 22 and preferably 12 to 18 carbon atoms and G stands for a glycose unit containing 5 or 6 carbon atoms, preferably glucose. The degree of oligomerization x, which defines the distribution of monoglycosides and oligoglycosides, is any number between 1.0 and 10, preferably between 1.2 and 1.4.

Another class of preferred non-ionic surfactants which are used either as the sole non-ionic surfactant or in combination with other non-ionic surfactants, are alkoxylated, preferably ethoxylated or ethoxylated and propoxylated fatty acid alkyl esters preferably containing 1 to 4 carbon atoms in the alkyl chain, more particularly the fatty acid methyl esters which are described, for example, in Japanese patent application JP 58/217598 or which are preferably produced by the process described in International Patent application WO-A-90/13533.

Non-ionic surfactants of the amine oxide type, for example N-coco alkyl-N,N-dimethylamine oxide and N-tallow alkyl-N,N-dihydroxyethylamine oxide, and the fatty acid alkanolamides may also be suitable. The quantity in which these non-ionic surfactants are used is preferably no more than the quantity in which the ethoxylated fatty alcohols are used and, particularly no more than half that quantity.

Other suitable surfactants are polyhydroxyfatty acid amides corresponding to the Formula (2),

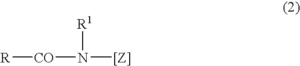

in which RCO stands for an aliphatic acyl group with 6 to 22 carbon atoms, R¹ for hydrogen, an alkyl or hydroxyalkyl group with 1 to 4 carbon atoms and [Z] for a linear or branched polyhydroxyalkyl group with 3 to 10 carbon atoms and 3 to 10 hydroxyl groups. The polyhydroxyfatty acid amides are known substances, which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds corresponding to Formula (3),

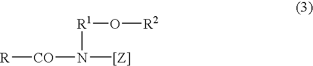

in which R is a linear or branched alkyl or alkenyl group containing 7 to 12 carbon atoms, R¹ is a linear, branched or cyclic alkyl group or an aryl group containing 2 to 8 carbon atoms and R² is a linear, branched or cyclic alkyl group or an aryl group or an oxyalkyl group containing 1 to 8 carbon atoms, C₁₋₄ alkyl or phenyl groups being preferred, and [Z] is a linear polyhydroxyalkyl group, of which the alkyl chain is substituted by at least two hydroxyl groups, or alkoxylated, preferably ethoxylated or propoxylated derivatives of that group.

[Z] is preferably obtained by reductive amination of a sugar, for example glucose, fructose, maltose, lactose, galactose, mannose or xylose. The N-alkoxy- or N-aryloxy-substituted compounds may then be converted, for example according to the teaching of the international application WO-A-95/07331, into the required polyhydroxyfatty acid amides by reaction with fatty acid methyl esters in the presence of an alkoxide as catalyst.

The content of non-ionic surfactants in the liquid detergents and cleaning agents is preferably 5 to 30 wt. %, advantageously 7 to 20 wt. % and particularly 9 to 15 wt. %, in each case based on the total weight of the agent.

Exemplary suitable anionic surfactants are those of the sulfonate and sulfate type. Suitable surfactants of the sulfonate type are, advantageously C₉₋₁₃ alkylbenzene sulfonates, olefin sulfonates, i.e. mixtures of alkene- and hydroxyalkane sulfonates, and disulfonates, as are obtained, for example, from C₁₂₋₁₈ monoolefins having a terminal or internal double bond, by sulfonation with gaseous sulfur trioxide and subsequent alkaline or acidic hydrolysis of the sulfonation products. Those alkane sulfonates, obtained from C₁₂₋₁₈ alkanes by sulfochlorination or sulfoxidation, for example, with subsequent hydrolysis or neutralization, are also suitable. The esters of α-sulfofatty acids (ester sulfonates), e.g. the α-sulfonated methyl esters of hydrogenated coco-, palm nut- or tallow acids are likewise suitable.

Further suitable anionic surfactants are sulfated fatty acid esters of glycerine. They include the mono-, di- and triesters and also mixtures of them, such as those obtained by the esterification of a monoglycerine with 1 to 3 moles fatty acid or the transesterification of triglycerides with 0.3 to 2 moles glycerine. Preferred sulfated fatty acid esters of glycerol in this case are the sulfated products of saturated fatty acids with 6 to 22 carbon atoms, for example caproic acid, caprylic acid, capric acid, myristic acid, lauric acid, palmitic acid, stearic acid or behenic acid.

Preferred alk(en)yl sulfates are the alkali and especially sodium salts of the sulfuric acid half-esters derived from the C₁₂-C₁₈ fatty alcohols, for example from coconut butter alcohol, tallow alcohol, lauryl, myristyl, cetyl or stearyl alcohol or from C₁₀-C₂₀ oxo alcohols and those half-esters of secondary alcohols of these chain lengths. Additionally preferred are alk(en)yl sulfates of the said chain lengths, which contain a synthetic, straight-chained alkyl group produced on a petrochemical basis and which show similar degradation behavior to the suitable compounds based on fat chemical raw materials. The C₁₂-C₁₆ alkyl sulfates and C₁₂-C₁₅ alkyl sulfates and C₁₄-C₁₅ alkyl sulfates are preferred on the grounds of laundry performance. The 2,3-alkyl sulfates, which are manufactured according to the U.S. Pat. Nos. 3,234,258 or 5,075,041, and which can be obtained from Shell Oil Company under the trade name DAN®, are also suitable anionic surfactants.

Sulfuric acid mono-esters derived from straight-chained or branched C₇₋₂₁ alcohols ethoxylated with 1 to 6 moles ethylene oxide are also suitable, for example 2-methyl-branched C₉₋₁₁, alcohols with an average of 3.5 mole ethylene oxide (EO) or C₁₂₋₁₈ fatty alcohols with 1 to 4 EO. Due to their high foaming performance, they are only used in fairly small quantities in cleaning agents, for example in amounts of 1 to 5% by weight.

Other suitable anionic surfactants are the salts of alkylsulfosuccinic acid, which are also referred to as sulfosuccinates or esters of sulfosuccinic acid and the monoesters and/or di-esters of sulfosuccinic acid with alcohols, preferably fatty alcohols and especially ethoxylated fatty alcohols. Preferred sulfosuccinates contain C₈₋₁₈ fatty alcohol groups or mixtures of them. Especially preferred sulfosuccinates comprise a fatty alcohol group derived from ethoxylated fatty alcohols and may be considered as non-ionic surfactants (see description below). Once again the especially preferred sulfosuccinates are those, whose fatty alcohol groups are derived from ethoxylated fatty alcohols with narrow range distribution. It is also possible to use alk(en)ylsuccinic acids with preferably 8 to 18 carbon atoms in the alk(en)yl chain, or salts thereof.

Particularly preferred anionic surfactants are soaps. Saturated and unsaturated fatty acid soaps are suitable, such as the salts of lauric acid, myristic acid, palmitic acid, stearic acid, (hydrogenated) erucic acid and behenic acid, and especially soap mixtures derived from natural fatty acids such as coconut oil fatty acid, palm kernel oil fatty acid, olive oil fatty acid or tallow fatty acid.

Anionic surfactants, including soaps may be in the form of their sodium, potassium or ammonium salts or as soluble salts of organic bases, such as mono-, di- or triethanolamine. Preferably, the anionic surfactants are in the form of their sodium or potassium salts, especially in the form of sodium salts.

The content of anionic surfactants in the preferred liquid detergents and cleaning agent is 2 to 30 wt. %, preferably 4 to 25 wt. % and particularly 5 to 22 wt. %, in each case based on the total weight of the agent.

The viscosity of the liquid detergents and cleaning agents can be measured using standard methods (for example using a Brookfield-Viscosimeter LVT-II at 20 rpm and 20° C., spindle 3) and lies preferably in the range from 500 to 5000 mPas. Preferred agents have viscosities from 700 to 4000 mPas, particularly preferably from 1000 to 3000 mPas.

In addition to the capsules and to the surfactant(s), the liquid detergents and cleaning agents can comprise additional ingredients that further improve the application technological and/or aesthetic properties of the liquid detergent and cleaning agent. In the context of the present invention, preferred agents comprise, in addition to the capsules and the surfactant(s), one or a plurality of materials from the group of the builders, bleaching agents, bleach activators, enzymes, electrolytes, non-aqueous solvents, pH adjustors, fragrances, perfume carriers, fluorescent agents, dyes, hydrotropes, foam inhibitors, silicone oils, anti-redeposition agents, optical brighteners, graying inhibitors, anti-shrink products, anti-creasing agents, color transfer inhibitors, antimicrobials, germicides, fungicides, antioxidants, corrosion inhibitors, antistats, ironing aids, water-repellents and impregnation agents, swelling and non-skid agents and UV-absorbers.

Silicates, aluminum silicates (particularly zeolites), carbonates, salts of organic di- and polycarboxylic acids as well as mixtures of these materials can be particularly cited as builders that are comprised in the liquid detergents and cleaning agents.

Suitable crystalline, layered sodium silicates correspond to the general formula NaMSiₓO₂ₓ₊₁.H₂O, wherein M is sodium or hydrogen, x is a number from 1.9 to 4 and y is a number from 0 to 20, preferred values for x being 2, 3 or 4. These types of crystalline layered silicates are described, for example, in the European Patent application EP-A-0 164 514. Preferred crystalline layered silicates of the given formula are those in which M stands for sodium and x assumes the values 2 or 3. Both β- and δ-sodium disilicate Na₂Si₂O₅ yH₂O are particularly preferred, wherein β-sodium disilicate can be obtained for example from the process described in the international patent application WO-A-91/08171.

Other useful builders are amorphous sodium silicates with a modulus (Na₂O: SiO₂ ratio) of 1:2 to 1:3.3, preferably 1:2 to 1:2.8 and more preferably 1:2 to 1:2.6, which dissolve with a delay and exhibit multiple wash cycle properties. The delay in dissolution compared with conventional amorphous sodium silicates can have been obtained in various ways, for example by surface treatment, compounding, compressing/compacting or by over-drying. In the context of this invention, the term “amorphous” also means “X-ray amorphous”. In other words, the silicates do not produce any of the sharp X-ray reflections typical of crystalline substances, but at best one or more maxima of the scattered X-radiation, which have a width of several degrees of the diffraction angle. However, particularly good builder properties may even be achieved where the silicate particles produce indistinct or even sharp diffraction maxima in electron diffraction experiments. This can be interpreted to mean that the products have microcrystalline regions between 10 and a few hundred nm in size, values of up to at most 50 nm and especially up to at most 20 nm being preferred. This type of X-ray amorphous silicates, which similarly possess a delayed dissolution in comparison with the customary water glasses, are described, for example in the German patent application DE-A-44 00 024. Compacted/densified amorphous silicates, compounded amorphous silicates and over dried X-ray-amorphous silicates are particularly preferred.

Of the suitable fine crystalline, synthetic zeolites containing bound water, zeolite A and/or P are preferred. Zeolite MAP® (commercial product of the Crosfield company), is particularly preferred as the zeolite P. However, zeolite X and mixtures of A, X, Y and/or P are also suitable. Commercially available and preferably used in the context of the present invention is, for example, also a co-crystallizate of zeolite X and zeolite A (ca. 80 wt. % zeolite X), which is marketed by the SASOL Company under the trade name VEGOBOND AX® and which can be described by the Formula to polyacylated alkylenediamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenol sulfonates, in particular n-nonanoyl- or isononanoyloxybenzene sulfonate (n- or iso-NOBS), carboxylic acid anhydrides, in particular phthalic anhydride, acylated polyhydric alcohols, in particular triacetin, ethylene glycol diacetate and 2,5-diacetoxy-2,5-dihydrofuran.

In addition to, or instead of the conventional bleach activators, so-called bleach catalysts may also be incorporated into the liquid detergents and cleaning agents. These substances are bleach boosting transition metal salts or transition metal complexes such as, for example, salen or carbonyl complexes of manganese, iron, cobalt, ruthenium or molybdenum. Manganese, iron, cobalt, ruthenium, molybdenum, titanium, vanadium and copper complexes with nitrogen-containing tripod ligands and cobalt-, iron-, copper- and ruthenium-ammine complexes may also be used as bleach catalysts.

The liquid detergent and cleaning agent preferably comprises a thickener. The thickener can include, for example a polyacrylate-thickener, Xanthane gum, gellan gum, guar nut flour, alginate, carragheenan, carboxymethyl cellulose, bentonite, wellan gum, locust bean flour, agar-agar, traganth, gummi arabicum, pectins, polyoses, starches, dextrins, gelatines and casein. Modified natural products, such as modified starches and celluloses, examples being carboxymethyl cellulose and other cellulose ethers, hydroxyethyl and hydroxypropyl cellulose as well as bean flour ether, can also be employed as the thickener.

The polyacrylic and polymethacrylic thickeners include, for example, the high molecular weight homopolymers of acrylic acid, crosslinked with a polyalkenyl polyether, in particular an allyl ether of saccharose, pentaerythritol or propylene (INCI name according to the “International Dictionary of Cosmetic Ingredients” of The Cosmetic, Toiletry and Fragrance Association (CTFA): Carbomer), which are also called carboxyvinyl polymers. Such polyacrylic acids are available inter alia from 3V Sigma Company under the trade name Polygel®, e.g. Polygel DA, and from the B.F. Goodrich Company under the trade name Carbopol®, e.g. Carbopol 940 (molecular weight ca. 4 000 000), Carbopol 941 (molecular weight ca. 1 250 000) or Carbopol 934 (molecular weight ca. 3 000 000). In addition, the following acrylic acid copolymers fall in this category: (i) copolymers of two or more monomers from the group of acrylic acid, methacrylic acid and their simple esters, preferably formed with C₁₋₄ alcohols, (INCI Acrylates Copolymer), to which belong, for example, the copolymers of methacrylic acid, butyl acrylate and methyl methacrylate (CAS number according to Chemical Abstracts Service: 25035-69-2) or of butyl acrylate and methyl methacrylate (CAS 25852-37-3) and which are available, for example, from Rohm & Haas under the trade names Aculyn® and Acusol®, and from Degussa (Goldschmidt) under the trade names Tego® Polymer, e.g. the anionic non-associative polymers Aculyn 22, Aculyn 28, Aculyn 33 (crosslinked), Acusol 810, Acusol 820, Acusol 823 and Acusol 830 (CAS 25852-37-3); (ii) crosslinked high molecular weight acrylic acid copolymers that include, for example copolymers of C₁₀₋₃₀ alkyl acrylates and one or more monomers from the group of acrylic acid, methacrylic acid and their simple esters, preferably formed with C₁₋₄ alcohols, which are crosslinked with an allyl ether of saccharose or of pentaerythritol (INCI Acrylates/C₁₀₋₃₀ alkyl acrylate crosspolymer) and which are available from the B.F. Goodrich Company under the trade name Carbopol®, e.g. the hydrophobized Carbopol ETD 2623 and Carbopol 1382 (INCI Acrylates/C₁₀₋₃₀ Alkyl Acrylate Crosspolymer) as well as Carbopol Aqua 30 (previously Carbopol EX 473).

A further preferred employable polymeric thickener is Xanthane gum, a microbial anionic heteropolysaccharide that is produced under aerobic conditions by Xanthomonas campestris and some other species, and which has a molecular weight of 2 to 15 million Dalton. Xanthane is formed from a chain of linked β-1,4-glucose (cellulose) with side chains. The agent of the sub-groups consists of glucose, mannose, glucuronic acid, acetate and pyruvate, wherein the number of pyruvate units determines the viscosity of the Xanthane gum.

Xanthane gum can be described by the following Formula (1)

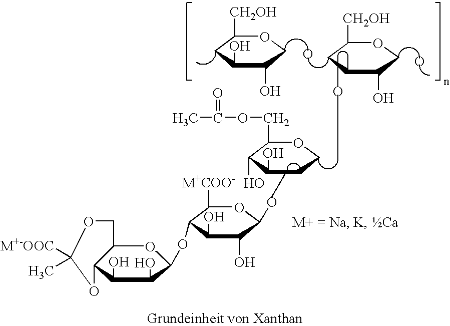

Xanthane gum is available, for example, from Kelco under the trade name Keltrol® and Kelzan® or also from Rhodia under the trade name Rhodopol®.

Preferred aqueous liquid detergents and cleaning agents comprise 0.01 to 1 wt. % and preferably 0.1 to 0.5 wt. % thickener, based on the total agent.

The aqueous liquid detergent and cleaning agent can comprise encapsulated enzymes and/or enzymes directly in the detergent and cleaning agent. Suitable enzymes are, in particular, those from the classes of hydrolases, such as proteases, esterases, lipases or lipolytic enzymes, amylases, cellulases or other glycosyl hydrolases and mixtures thereof. In the wash, all these hydrolases contribute to removing stains such as protein, fat or starchy stains and against graying. Moreover, cellulases and other glycosyl hydrolases can contribute to increased softness of the textile and to color retention by removing pilling and micro fibrils. Oxireductases can also be added for bleaching or for reducing color transfer. Enzymatic active materials obtained from bacterial sources or fungi such as bacillus subtilis, bacillus licheniformis, streptomyceus griseus and humicola insolens are particularly well suited. Proteases of the subtilisin type and particularly proteases that are obtained from bacillus lentus, are preferably used. Here, mixtures of enzymes are of particular interest, for example proteases and amylases or proteases and lipases or lipolytic enzymes or proteases and cellulases or cellulases and lipase or lipolytic enzymes or proteases, amylases and lipases or lipolytic enzymes or proteases, lipases or lipolytic enzymes and cellulases, in particular, however, proteases and/or lipase-containing mixtures or mixtures with lipolytic enzymes. Examples of such lipolytic enzymes are the known cutinases. Peroxidases or oxidases have also proved to be suitable in certain cases. The suitable amylases particularly include α-amylases, iso-amylases, pullulanases and pectinases. Cellobiohydrolases, endoglucanases and β-glucosidases or mixtures thereof, which are also known as cellobiases and are preferred cellulases. As the different cellulase types differ in their CMCase- and avicelase activities, the required activities can be adjusted by means of controlled mixtures of the cellulases.

The enzymes can be adsorbed on carriers in order to protect them against premature decomposition. The content of the enzymes, enzyme mixtures or enzyme granules directly in the detergent and cleaning agent may be, for example, about 0.1 to 5% by weight and is preferably 0.12 to about 2.5% by weight.

A large number of the most varied salts can be employed as the electrolytes from the group of the inorganic salts. Preferred cations are the alkali and alkaline earth metals, preferred anions are the halides and sulfates. The addition of NaCl or MgCl₂ to the agents is preferred from the industrial manufacturing point of view. The content of electrolytes in the agents normally ranges from 0.5 to 5 wt. %.

Non-aqueous solvents that can be added to the liquid detergents and cleaning agents originate for example from the group of mono- or polyhydric alcohols, alkanolamines or glycol ethers, in so far that they are miscible with water in the defined concentrations. Preferably, the solvents are selected from ethanol, n- or i-propanol, butanols, glycol, propane diol or butane diol, glycerine, diglycol, propyl diglycol or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl-, -ethyl- or -propyl ether, butoxy propoxy propanol (BPP), dipropylene glycol methyl-, or -ethyl ether, diisopropylene glycol methyl-, or -ethyl ether, methoxy-, ethoxy- or butoxy triglycol, 1-butoxyethoxy-2-propanol, 3-methyl-3-methoxybutanol, propylene glycol t-butyl ether as well as mixtures of these solvents. Non-aqueous solvents can be added to the liquid detergent and cleaning agents in amounts between 0.5 and 15 wt. %, preferably, however below 12 wt. % and particularly below 9 wt. %.

The addition of pH adjustors can be considered for bringing the pH of the detergents and cleaning agent into the desired range. Any known acid or alkali can be added, in so far as their addition is not forbidden on technological or ecological grounds or grounds of protection of the consumer. The amount of these adjustors does not normally exceed 7 wt. % of the total formulation.

In order to enhance the aesthetic impression of the liquid detergents and cleaning agents of the invention, they may be colored with appropriate colorants. Preferred colorants, which are not difficult for the expert to choose, have high storage stability, are not affected by the other ingredients of the detergents or by light and do not have any pronounced substantivity for the textile fibers being treated, so as not to color them.

Soaps, paraffins or silicone oils, optionally deposited on carrier materials, are examples of the foam inhibitors that can be added to the liquid detergents and cleaning agents. Suitable anti-redeposition agents, also referred to as soil repellents are, for example, non-ionic cellulose ethers such as methyl cellulose and methyl hydroxypropyl cellulose with a content of methoxy groups of 15 to 30 wt. % and hydroxypropyl groups of 1 to 15 wt. %, each based on the non-ionic cellulose ether, as well as polymers of phthalic acid and/or terephthalic acid or their derivatives known from the prior art, particularly polymers of ethylene terephthalates and/or polyethylene glycol terephthalates or anionically and/or non-ionically modified derivatives thereof. From these, the sulfonated derivatives of the phthalic acid polymers and the terephthalic acid polymers are particularly preferred.

Optical brighteners (so called “whiteners”) can be added to the liquid detergents and cleaning agents in order to eliminate graying and yellowing of the treated textile fabrics. These materials absorb onto the fiber and effect a brightening and pseudo bleach effect in that the invisible ultraviolet radiation is converted into visible radiation, wherein the ultraviolet light absorbed from sunlight is irradiated away as weak blue fluorescence and results in pure white for the yellow shade of the grayed or yellowed washing. Suitable compounds originate for example from the substance classes of 4,4′-diamino-2,2′-stilbenedisulfonic acids (flavonic acids), 4,4′-distyrylbiphenylene, methyl umbelliferone, coumarone, dihydroquinolinones, 1,3-diarylpyrazolines, naphthoic acid imide, benzoxazole-, benzisoxazole- and benzimidazole systems as well as heterocyclic substituted pyrene derivatives. Optical brighteners are usually added in amounts between 0.03 and 0.3 wt. %, based on the finished agent.

Graying inhibitors have the function of maintaining the dirt that was removed from the fibers suspended in the washing liquor, thereby preventing the dirt from resettling. Water-soluble colloids of mostly organic nature are suitable for this, for example glue, gelatines, salts of ether sulfonic acids of starches or celluloses, or salts of acidic sulfuric acid esters of celluloses or starches. Water-soluble, acid group-containing polyamides are also suitable for this purpose. In addition, soluble starch preparations and others can be used as the abovementioned starch products, e.g. degraded starches, aldehyde starches etc. Polyvinyl pyrrolidone can also be used. Preference, however, is given to the use of cellulose ethers such as carboxymethyl cellulose (Na salt), methyl cellulose, hydroxyalkyl cellulose and mixed ethers such as methyl hydroxyethyl cellulose, methyl hydroxypropyl cellulose, methyl carboxymethyl cellulose and mixtures thereof, which can be added, for example in amounts of 0.1 to 5 wt. %, based on the agent.

As textile fabrics, particularly of rayon, spun rayon, cotton and their mixtures, can wrinkle of their own accord because the individual fibers are sensitive to flection, bending, pressing and squeezing at right angles to the fiber direction, the agents can comprise synthetic wrinkle-protection agents. They include for example synthetic products based on fatty acids, fatty acid esters, fatty acid amides, fatty acid alkylol esters, fatty acid alkylol amides or fatty alcohols that have been mainly treated with ethylene oxide, or products based on lecithin or modified phosphoric acid esters.

The liquid detergents and cleaning agents can comprise antimicrobials to combat microorganisms. Depending on the antimicrobial spectrum and the action mechanism, antimicrobial agents are classified as bacteriostatic agents and bactericides, fungistatic agents and fungicides, etc. Important representatives of these groups are, for example, benzalkonium chlorides, alkylaryl sulfonates, halophenols and phenol mercuric acetate, wherein these compounds can also be totally dispensed with in the inventive compositions.

The agents can comprise additional antioxidants in order to prevent undesirable changes caused by oxygen and other oxidative processes to the liquid detergents and cleaning agents and/or the treated textile fabrics. This class of compounds includes, for example, substituted phenols, hydroquinones, pyrocatechols and aromatic amines as well as organic sulfides, polysulfides, dithiocarbamates, phosphites and phosphonates.

An increased wear comfort can result from the additional use of antistats that can be additionally included in the agents. Antistats increase the surface conductivity and thereby allow an improved discharge of built-up charges. Generally, external antistats are substances with at least one hydrophilic molecule ligand and provide a more or less hygroscopic film on the surfaces. These mainly interface active antistats can be subdivided into nitrogen-containing (amines, amides, quaternary ammonium compounds), phosphorus-containing (phosphoric acid esters) and sulfur-containing (alkyl sulfonates, alkyl sulfates) antistats. External antistats are described, for example, in the patent applications FR 1 156 513, GB 873 214 and GB 839 407. Lauryl (or stearyl) dimethyl benzyl ammonium chlorides disclosed here are suitable antistats for textile fabrics or as additives to detergents, resulting in an additional finishing effect.

Silicone derivatives, for example, can be added to the liquid detergents and cleaning agents to improve the water-absorption capacity, the wettability of the treated textile fabrics and to facilitate ironing of the treated fabrics. They additionally improve the final rinse behavior of the agents by means of their foam-inhibiting properties. Exemplary preferred silicone derivatives are polydialkylsiloxanes or alkylarylsiloxanes, in which the alkyl groups possess one to five carbon atoms and are totally or partially fluorinated. Preferred silicones are polydimethylsiloxanes that can be optionally derivatized and then are aminofunctional or quaternized or possess Si—OH, Si—H and/or SiCl bonds. The viscosities of the preferred silicones at 25° C. are in the range between 100 and 100 000 mPas, wherein the silicones can be added in amounts between 0.2 and 5 wt. % based on the total agent.

Finally, the liquid detergents and cleaning agents can also comprise UV absorbers that are absorbed on the treated textile fabrics and improve the light stability of the fibers. Compounds, which possess these desired properties, are for example, the efficient radiationless deactivating compounds and derivatives of benzophenone having substituents in position(s) 2 and/or 4. Also suitable are substituted benzotriazoles, acrylates, which are phenyl-substituted in position 3 (cinnamic acid derivatives) optionally with cyano groups in position 2), salicylates, organic Ni complexes, as well as natural substances such as umbelliferone and the endogenous urocanic acid.

Substances can be added to complex heavy metals in order to prevent heavy metal catalyzed decomposition of certain detergent ingredients. Suitable heavy metal sequestrants are, for example, the alkali salts of ethylene diamine tetra acetic acid (EDTA) or of nitrilotriacetic acid (NTA) as well as alkali metal salts of anionic polyelectrolytes such as polyacrylates, polymaleates and polysulfonates.

A preferred class of sequestrants are the phosphonates that are comprised in the preferred detergents and cleaning agents in amounts of 0.01 to 2.5 wt. %, preferably 0.02 to 2 wt. % and particularly 0.03 to 1.5 wt. %. These preferred compounds particularly include organophosphonates, such as for example 1-hydroxyethane-1,1-diphosphonic acid (HEDP), aminotri(methylenephosphonic acid) (ATMP), diethylene triamine penta(methylenephosphonic acid) (DTPMP or DETPMP) as well as 2-phosphonobutane-1,2,4-tricarboxylic acid (PBS-AM), that are mainly added in the form of their ammonium or alkali metal salts.

The resulting aqueous liquid detergents and cleaning agents are preferably clear, i.e. they do not exhibit any sediment and are particularly preferably transparent or at least translucent.

The detergents and cleaning agents can be used for cleaning textile fabrics.

To prepare the liquid detergent and cleaning agent with gellan gum as the thickener, gellan gum is firstly placed in water and allowed to swell at 80° C. A small quantity of a salt solution, preferably containing tri- or divalent metal cations such as Al³⁺ or Ca²⁺, is then added. In the next step, the acidic components, such as for example the linear alkylsulfonates, citric acid, boric acid, phosphonic acid, the fatty alcohol ether sulfates, etc., and the non-ionic surfactants are added. A base, such as for example NaOH, KOH, triethanolamine or monoethanolamine, is then added, followed by the fatty acid, when available. Subsequently, the remaining ingredients and the solvent of the liquid detergent and cleaning agent are added, together with the polyacrylate thickener, when available, to the mixture and the pH adjusted to about 8.5. Finally, the particles to be dispersed are added and dispersed homogeneously in the liquid detergent and cleaning agent with stirring and/or mixing.

The liquid detergent and cleaning agent without gellan gum is prepared by usual and known methods and processes by, for example simply blending the ingredients in stirred tanks, wherein water, non-aqueous solvents and surfactant(s) are advantageously present and the other ingredients are added portion wise. Separate heating is not required during the preparation, but if desired then the temperature should not exceed 80° C.

The capsules can be dispersed in the liquid detergent and cleaning agent to afford a stable dispersion. Stable means that the agents are stable at room temperature and at 40° C. for a period of at least 4 weeks and preferably for at least 6 weeks without the agents creaming or precipitating.

### EXAMPLES

### Example 1

Various capsules K1 to K6 containing alginate as the matrix material were prepared or dripped in a hardening bath by means of a Rieter dripping unit.

The compositions of each of the alginate solutions are shown in Table 1 (data in wt. %).

| | K1 | K2 | K3 | K4 | K5 | K6 |
|---|---|---|---|---|---|---|
| Na alginate | 1 | 1 | 1 | 1 | 1 | 1 |
| Aerosil 200 | 3 | 3 | 3 | — | — | — |
| Sipernat 22S | — | — | — | 3 | 3 | 3 |
| Hollow | 2 | 2 | 2 | 2 | 2 | 2 |
| micro spheres¹ | | | | | | |
| Preservative | 0.05 | 0.05 | 0.05 | 0.05 | 0.05 | 0.05 |
| Colorant | 0.1 | 0.1 | 0.1 | 0.1 | 0.1 | 0.1 |
| Cellulase | 1 | 0.5 | 0.1 | 1 | 0.5 | 0.1 |
| Cellulose | 2 | 1 | 0.2 | 2 | 1 | 0.4 |
| Water | ad 100 | ad 100 | ad 100 | ad 100 | ad 100 | ad 100 |

¹ceramic hollow micro spheres with a diameter between 10 to 125 μm and a density between 0.5 and 0.7 g · cm⁻³.
The hardening bath comprised
2.5 wt. % CaCl₂
0.2 wt. % polydiallyl dimethyl ammonium chloride
0.05 wt. % preservative
and completed to 100 wt. % with water.

The resulting capsules K1 to K6 were washed several times with water and a sequestrant, such as for example Dequest®.

The capsules K1 and K2 were then stored in water for 2 weeks at room temperature. The following values were determined from the subsequent enzyme analysis of the capsules K1 and K2 and the surrounding solution:

| | Cellulase | |
|---|---|---|
| Sample | [mU/g] | activity Cellulase content [%] |
| Capsule K1 | 105.0 | 0.39 |
| Capsule K2 | 89.5 | 0.33 |
| Storage solution of K1 | 3.5 | 0.01 |
| Storage solution of K2 | 2.9 | 0.01 |

In comparative experiments, capsules with the compositions of Table 1 were prepared without cellulose, however, and stored in water at room temperature. After a short storage period it was found that there was exactly as much enzyme in the storage solution as in the capsule itself.

These experiments clearly show that an active ingredient, here cellulase, can be effectively immobilized by binding it onto a substrate, the example here being cellulose. Diffusion of the active ingredient out of the capsule is prevented by the immobilization.

The inventive capsules can be dispersed in liquid detergent and cleaning agents of the most different compositions to form a stable dispersion. Stable means that the agents are stable at room temperature and at 40° C. for a period of at least 4 weeks and preferably for at least 6 weeks without the agents creaming or precipitating.

Inventive detergents and cleaning agents E1 to E4 are shown in Table 2. The resulting detergents and cleaning agents E1 to E4 have a viscosity around 1000 mPas. The pH of the liquid detergents and cleaning agents was 8.5.

TABLE 2

| | E1 | E2 | E3 | E4 |
|---|---|---|---|---|
| Gellan gum | 0.2 | 0.2 | 0.15 | — |
| Xanthane gum | — | — | 0.15 | — |
| Polyacrylate (Carbopol Aqua | 0.4 | 0.4 | — | 0.6 |
| 30) | | | | |
| C₁₂₋₁₄ fatty alcohol with 7 EO | 22 | 10 | 10 | 10 |
| C₉₋₁₃ alkylbenzenesulfonate, Na | — | 10 | 10 | 10 |
| salt | | | | |
| C₁₂₋₁₄ alkyl polyglycoside | 1 | — | — | — |
| Citric acid | 1.6 | 3 | 3 | 3 |
| Phosphonic acid | 0.5 | 1 | 1 | 1 |
| Sodium lauryl ether sulfate with | 10 | 5 | 5 | — |
| 2 EO | | | | |
| Monoethanolamine | 3 | 3 | 3 | — |
| C₁₂₋₁₈ fatty acid | 7.5 | 7.5 | 7.5 | 5 |
| Propylene glycol | — | 6.5 | 6.5 | — |
| Na cumenesulfonate | — | 2 | 2 | — |
| Boric acid | — | — | — | 1 |
| Enzymes, colorants, stabilizers | + | + | + | + |
| Capsules K1 with ca. 2000 μm | 0.5 | 0.5 | 0.5 | 0.5 |
| Ø | | | | |
| Water | ad 100 | ad 100 | ad 100 | ad 100 |

### Example 2

Capsules K7 containing alginate as the matrix material were prepared or dripped in a hardening bath (composition as in example 1) by means of a Rieter dripping unit.

The composition of the alginate solution is shown in Table 3 (data in wt. %).

TABLE 3

| | K7 |
|---|---|
| Na alginate | 1 |
| Aerosil 200 | — |
| Sipernat 22S | 3 |
| Hollow | 3 |
| micro spheres¹ | |
| Preservative | 0.05 |
| Colorant | 0.1 |
| Termamyl 300 LDX | 1 |
| Corn starch | 2.5 |
| Water | ad 100 |

¹ceramic hollow micro spheres with a diameter between 10 to 125 μm and a density between 0.5 and 0.7 g · cm⁻³.

The resulting capsules K7 were washed several times with water and a sequestrant, such as for example Dequest®.

The capsules K7 were then stored in water or liquid detergent E3 for 4 weeks at room temperature. The following values were determined from the subsequent enzyme analysis of the capsules K7 and the surrounding solution:

| Sample | Amylase content [%] |
|---|---|
| Capsule K7 in water | 2.9 |
| Capsule K7 in E3 | 2.9 |
| Storage solution water | 0.03 |
| Storage solution E3 | 0.03 |

In comparative experiments, capsules with the compositions of Table 3 were prepared without corn starch, however, and stored in water at room temperature. After a short storage period it was found that there was exactly as much enzyme in the storage solution as in the capsule itself.

1-15. (canceled)

16. An aqueous composition comprising a surfactant and a capsule, wherein the capsule comprises an immobilized active ingredient in a matrix, and wherein the active ingredient is bound to a substrate.

17. The composition according to claim 16, wherein the substrate has binding specificity for the active ingredient.

18. The composition according to claim 16, wherein the active ingredient comprises a component selected from the group consisting of enzymes, metal cations and combinations thereof.

19. The composition according to claim 17, wherein the active ingredient comprises a component selected from the group consisting of enzymes, metal cations and combinations thereof.

20. The composition according to claim 16, wherein the immobilized active ingredient comprises an enzyme-substrate complex.

21. The composition according to claim 16, wherein the active ingredient comprises an enzyme selected from the group consisting of cellulases, proteases, amylases, lipases and mixtures thereof.

22. The composition according to claim 19, wherein the enzyme-substrate complex comprises an enzyme selected from the group consisting of cellulases, proteases, amylases, lipases and mixtures thereof.

23. The composition according to claim 16, wherein the active ingredient comprises a cellulase and the substrate comprises a cellulose.

24. The composition according to claim 16, wherein the active ingredient comprises an amylase and the substrate comprises a corn starch.

25. The composition according to claim 16, wherein the capsule further comprises a hollow microsphere.

26. The composition according to claim 16, wherein the matrix comprises a material selected from the group consisting of carrageenans, alginates, gellan gums and mixtures thereof.

27. The composition according to claim 17, wherein the matrix comprises a material selected from the group consisting of carrageenans, alginates, gellan gums and mixtures thereof.

28. The composition according to claim 18, wherein the matrix comprises a material selected from the group consisting of carrageenans, alginates, gellan gums and mixtures thereof.

29. The composition according to claim 21, wherein the matrix comprises a material selected from the group consisting of carrageenans, alginates, gellan gums and mixtures thereof.

30. The composition according to claim 16, wherein the capsule further comprises a filler.

31. The composition according to claim 16, wherein the capsule further comprises a filler selected from the group consisting of silicic acids, aluminum silicates and mixtures thereof.

32. The composition according to claim 16, wherein the capsule has a diameter along its largest dimension of 0.01 to 10,000 μm.

33. A process comprising:
(a) binding an active ingredient to a substrate to form a substrate-bound active ingredient;
(b) incorporating the substrate-bound active ingredient in a matrix; and
(c) combining the matrix containing the substrate-bound active ingredient with a surfactant.

34. A capsule comprising an immobilized active ingredient in a matrix, wherein the active ingredient is bound to a substrate.

35. A method comprising: (a) providing a textile fabric; and (b) contacting the textile fabric with a composition according to claim 16.
